(19) United States
(12) Patent Application Publication
(10) Pub. No.: US 2005/0058896 A1
(43) Pub. Date: Mar. 17, 2005

(54) Non-aqueous electrolyte secondary battery

(76) Inventors: Hirokazu Nomura, Otokuni-gun (JP); Seiji Ishizawa, Takatsuki-shi (JP); Hiroshi Hattori, Ibaraki-shi (JP)

Correspondence Address: BIRCH STEWART KOLASCH & BIRCH, PO BOX 747, FALLS CHURCH, VA, 22040-0747, US

(21) Appl. No.: 10/936,507

(22) Filed: Sep. 9, 2004

(30) Foreign Application Priority Data
Sep. 11, 2003 (JP) 2003-320428

(51) Int. Cl. H01M 2/18; H01M 2/02

(52) U.S. Cl. 429/142; 429/94; 429/145; 429/164

(57) ABSTRACT

A non-aqueous electrolyte secondary battery comprises a positive electrode, a negative electrode, two kinds of separators and an non-aqueous electrolytic solution, wherein the positive electrode, the negative electrode and the separators are laminated and wound to form a wound electrode body. The secondary battery is characterized in that the first separator having a gas permeability of 400 sec/100 cm³ or less is provided on the outer surface of the negative electrode, and the second separator having a coefficient of thermal shrinkage of 30% or less in a transverse direction is provided on the inner surface of the negative electrode.

### FIELD OF THE INVENTION

The present invention relates to a non-aqueous electrolyte secondary battery.

### PRIOR ART

Demands for non-aqueous electrolyte secondary batteries represented by lithium-ion secondary batteries have been increased year by year, and they are loaded into advanced portable electronic devices such as mobile phones, video cameras, etc., since they generate a high voltage and a high output and have a light weight and a high energy density. Recently, the performances of such electronic devices have been remarkably improved. With such improvement of the performances of the devices, demands for the higher performances, in particular, the higher capacity of the non-aqueous electrolyte secondary batteries which are loaded into the devices are rising rapidly.

At present, studies and developments to increase the capacity of non-aqueous electrolyte secondary batteries are extensively carried out. As one solution, Japanese Patent No. 3,422,284 proposes a secondary battery comprising a positive electrode and a negative electrode, each of which is stored in a bag-form separator and laminated, wherein the separators for the positive and negative electrodes are made of different materials. Furthermore, JP-A-5-13062 and JP-A-2002-25526 propose a laminated separator comprising different kinds of separators having different melting points.

In some cases, a separator, which can prevent the thermal runaway or heat crash of a battery when the battery is abnormally heated, may cause the thermal run away when the battery is overcharged. Contrary thereto, a separator, which can prevent the thermal runaway or heat crash of a battery when the battery is overcharged, may cause the thermal runaway when the battery is abnormally heated.

### SUMMARY OF THE INVENTION

Accordingly, the object of the present invention is to provide a non-aqueous electrolyte secondary battery having a high capacity and excellent safety, which can prevent the runaway of the battery when it is abnormally heated and also when it is overcharged.

To achieve the above object, the present invention provides a non-aqueous electrolyte secondary battery comprising a positive electrode, a negative electrode and two kinds of separators which are laminated and wound to form a wound electrode body, and a non-aqueous electrolytic solution, wherein the first separator having a gas permeability of 400 sec/100 cm³ or less is provided on the outer surface of the negative electrode, and the second separator having a coefficient of thermal shrinkage of 30% or less in a width wise direction (herein after referred to “TD” (transverse direction)) is provided on the inner surface of the negative electrode.

Herein, a coefficient of thermal shrinkage of a separator is measured after keeping the separator at 150° C. for 3 hours.

In the secondary battery of the present invention, the first separator having a gas permeability of 400 sec/100 cm³ or less is provided on the outer surface of the negative electrode to which lithium ions are concentrated during charging, while the second separator having a coefficient of thermal shrinkage of 30% or less is provided on the inner surface of the negative electrode. Thereby, the thermal runaway of the battery can be prevented when the battery is overcharged and also when the battery is abnormally heated. Thus, the battery of the present invention has excellent safety.

### DETAILED DESCRIPTION OF THE INVENTION

The non-aqueous electrolyte secondary battery of the present invention comprises a positive electrode, a negative electrode, two kinds of separators and an non-aqueous electrolytic solution, wherein the positive electrode, the negative electrode and the separators are laminated and wound to form a wound electrode body. The secondary battery of the present invention is characterized in that the first separator having a gas permeability of 400 sec/100 cm³ or less is provided on the outer surface of the negative electrode, and the second separator having a coefficient of thermal shrinkage of 30% or less in TD is provided on the inner surface of the negative electrode.

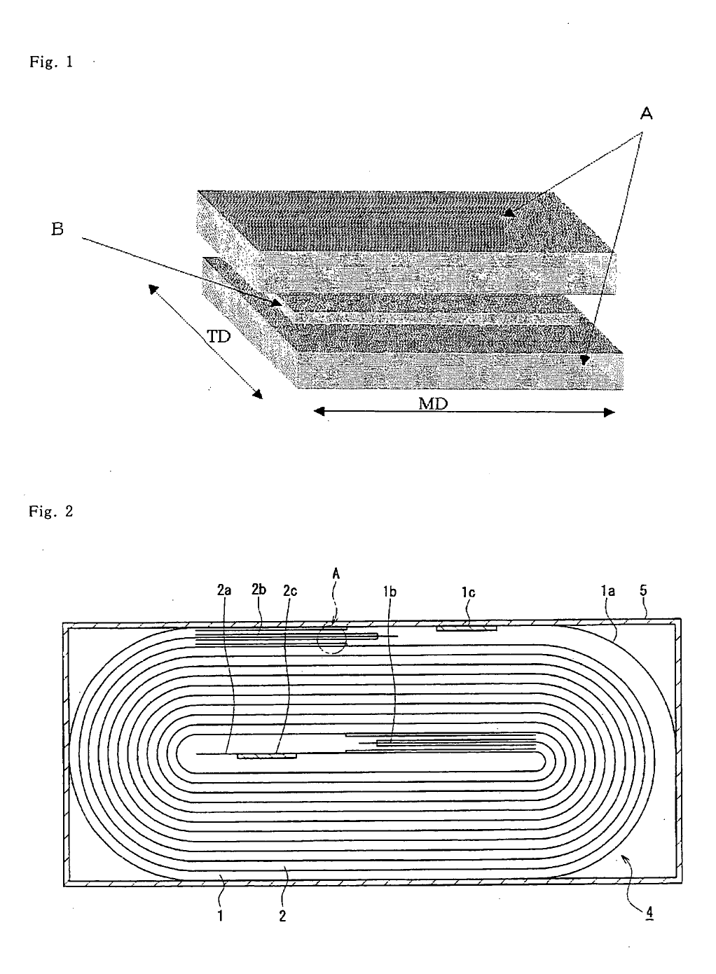

The method for measuring a coefficient of thermal shrinkage is explained by making reference to FIG. 1.

A separator (B) having a width of 45 mm (in TD) and a length of 60 mm (in a machine direction (MD)) is interposed between a pair of glass plates (A) with smooth surfaces, each of which has a size of 50 mm×80 mm and a weight of 47 g to simulate the internal structure of a battery. Then, the laminated structure is kept standing in a temperature-controlled chamber at 150° C. for 3 hours. Then, the structure is removed from the vessel while applying the weight of the glass plate (A) on the separator (B) and kept standing at a room temperature for 1 hour. Thereafter, the structure is disassembled, and the lengths of the separator (B) are measured at its center parts in TD and MD, and the coefficients of thermal shrinkage of the separator (B) are calculated according to the following formula:
Coefficient of thermal shrinkage=100×(L−L₀)/L
wherein L is the length of the separator after being kept at 150° C. for 3 hours, and Lo is the length of the separator before heating.

The gas permeability of a separator is measured according to JIS P8117.

When the thickness of each of the first and second separators is to large, the capacity of the battery decreases and the internal resistance of the battery increases. Therefore, the thickness of the separator is preferably 25 μm or less, more preferably 22 μm or less, particularly 20 μm or less.

To increase the capacity and the load characteristics of the battery, the thickness of each separator is preferably as small as possible. However, to maintain good mechanical strength and the good retention of an electrolytic solution and to prevent short-circuiting, the thickness of each separator is preferably at least 8 μm.

The gas permeability of the first separator is preferably 400 sec/100 cm³ or less, more preferably 250 sec/100 cm³ or less, and it is at least 50 sec/100 cm³. When the gas permeability of the first separator is too large, the conductivity of lithium ion decreases and thus the functions as the separator for the battery tend to deteriorate. When the gas permeability of the first separator is too small, the mechanical strength of the separator decreases.

The porosity of the first separator is preferably 60% or less, more preferably 50% or less since the separator may have low mechanical strength when its porosity is too large. The porosity of the first separator is preferably at least 30%, more preferably at least 45%, since the load characteristics of the battery can be increased while suppressing internal short-circuiting in this range.

The second separator preferably has a coefficient of thermal shrinkage of 30% or less, more preferably 25% or less in TD. The smaller coefficient of thermal shrinkage is advantageous to prevent the short-circuiting of the battery.

The porosity of the second separator is 60% or less, more preferably 55% or less, while it is preferably at least 30%, more preferably at least 35%, since the load characteristics of the battery can be increased while suppressing internal short-circuiting in this range.

The first and second separators may be produced from any material that is used to produce a separator of a conventional non-aqueous electrolyte secondary battery. For example, the separators are made of a non-woven fabric or a microporous film. Examples of the material of a non-woven fabric include polypropylene, polyethylene, polyethylene terephthalate, polybutylene terephthalate, etc. Examples of the material of a microporous film include polypropylene, polyethylene, ethylene-propylene copolymer, etc. The separators preferably have sufficient strength and maintain a larger amount of an electrolytic solution.

To control the thermal shrinkage of the separator, the separator is preferably heated at a temperature around 100° C. before it is assembled in the wound electrode body.

The wound electrode body is usually formed in the form of a cylinder having a circular or elliptical bottom, and stored in a battery exterior body consisting of a metal can. Accordingly, the shape of the battery may be a cylindrical battery or a prismatic battery. In addition, the battery may a prismatic battery a part of which has a curved surface, or a cylindrical battery a part of which has a flat surface.

The kind of a positive electrode active material used in the battery of the present invention is not limited. Preferably, the positive electrode active material generates an open-circuit voltage of at least 4 V versus lithium (Li) during charging. Examples of such a positive electrode active material include lithium-containing composite metal oxides such as lithium cobalt oxides (e.g. LiCoO₂), lithium manganese oxides (e.g. LiMnO₂), lithium nickel oxides (e.g. LiNiO₂), mixed oxides based on those lithium-containing oxides, for example, lithium-containing oxides a part of metals is substituted with other metals, mixtures of those oxides, and solid solutions of those oxides, and the like. Such positive electrode active materials can increase the energy density of the battery.

A positive electrode can be produced by a per se conventional method. For example, a paste containing a positive electrode active material, a binder and optionally a conductive aid such as flake-form graphite, carbon black, etc. is coated on a positive electrode collector and dried to form a coating layer containing the positive electrode active material and the binder. In the preparation of the paste comprising the positive electrode active material, the binder is used in the form of a solution in a solvent, and the solution of the binder and solid particles such as the positive electrode active material are mixed to obtain the paste.

The negative electrode may be made of any material that is conventionally used as a negative electrode of a secondary battery, insofar as the material can be doped or dedoped with lithium ion. Herein, all the materials that can be doped or dedoped with lithium ion are used as negative electrode active material. Examples of the negative electrode active material include graphite, pyrolysis carbons, cokes, glassy carbons, sintered materials of organic polymers, carbonaceous materials (e.g. mesocarbon microbeads, carbon fibers, activated carbons, etc.), alloys of lithium with aluminum, silicon, tin, indium, etc., oxidesofsilicon, tin, indium, etc. which can be charged and discharged at a low voltage close to the charge/discharge voltage of lithium, and the like.

A negative electrode can be produced by a per se conventional method. For example, a paste comprising the negative electrode active material, a binder, etc. is coated on a negative electrode collector and dried to form a coating layer containing the negative electrode active material and the binder.

When the carbonaceous material is used as the negative electrode material, it preferably has the following characteristics:

That is, the plane distance d₀₀₂ of the (002) planes of crystals of the carbonaceous material is preferably 0.350 nm or less, more preferably 0.345 nm or less, particularly 0.340 nm or less. The size of the crystallite in the c-axis direction (Lc) is preferably at least 3 nm, more preferably at least 8 nm, particularly at least 25 nm. The average particle size of the carbonaceous material is preferably from 10 to 30 μm, more preferably 15 to 25 μm. The content of the pure carbon component in the carbonaceous material is preferably at least 99.9% by weight.

The binder to be used in the positive and negative electrodes may be any one of conventionally used binders, for example, thermoplastic resins, rubbery elastic polymers, polysaccharides, etc. They may be used singly or as a mixture of two or more of them. Specific examples of the binder include polytetrafluoroethylene, polyvinylidene fluoride, polyethylene, polypropylene, ethylene-propylene copolymers, ethylene-propylene-diene copolymers, styrene-butadiene rubbers, polybutadiene, butyl rubber, fluororubber, polyethylene oxide, polyvinylpyrrolidone, polyepichlorohydrin, polyphosphazene, polyacrylonitrile, polystyrene, polyvinylpyridine, chlorosulfonatedpolyethylene, latexes, polyesterresins, acrylic resins, phenol resins, epoxy resins, polyvinyl alcohol, cellulose resins such as carboxymethylcellulose and hydroxypropylcellulose, etc.

In these years, binders which can be dissolved in water are often used in the production of the negative electrodes, since they exert the larger binding effects and thus increase the proportion of the active material in the electrode so that the battery capacity increases, in comparison with binders which are dissolved in organic solvents. In particular, the combination of a styrene-butadiene rubber and carboxymethylcellulose is preferable.

Examples of the collectors of the positive and negative electrodes include metal foils such as the foil of aluminum, copper, nickel, stainless steel, titanium, etc., expanded metals, metal nets, foam metals, and so on.

In particular, the collector of the positive electrode is preferably a foil comprising aluminum with a purity of 98 to 99.9% by weight. The thickness of the collector of the positive electrode is preferably from 5 to 60 μm, more preferably from 8 to 40 μm. The thickness of the coating layer of the positive electrode, that is, the layer of the positive electrode mixture, is preferably from 30 to 300 μm, more preferably from 50 to 150 μm, per one side.

Usually, the collector of the negative electrode is preferably a copper foil, in particular, an electrolytic copper foil. The thickness of the collector of the negative electrode is preferably from 5 to 60 μm, more preferably from 8 to 40 μm. The thickness of the coating layer of the negative electrode, that is, the layer of the negative electrode mixture, is preferably from 30 to 300 μm, more preferably from 50 to 150 μm, per one side.

In the production of the positive or negative electrode, the electrode active material paste may be coated on the collector by a per se conventional method, for example, with an extrusion coater, a reverse roll coater, a doctor blade, etc.

The non-aqueous electrolyte secondary battery of the present invention comprises a liquid electrolyte (hereinafter referred to as an “electrolytic solution”). Concretely, a non-aqueous electrolytic solution, namely, a solution of an electrolyte in an organic solvent is used. The kind of the organic solvent is not limited. Preferably, a linear ester is used as a primary solvent. Examples of the linear ester include organic solvents having a COO-bond in the molecule such as diethyl carbonate (DEC), dimethyl carbonate (DMC), ethyl methyl carbonate (EMC), ethyl acetate (EA), methyl propionate (MP), etc. To be used as a primary solvent means that the linear ester constitutes at least 50% by volume, preferably at east 65% by volume, more preferably at least 70% by volume, particularly at least 75% by volume based on the whole volume of the solvent of the electrolytic solution.

Besides the linear ester, the solvent of the electrolytic solution preferably contains an ester having a high dielectric constant, for example, a dielectric constant of at least 30 to increase the battery capacity. The content of the ester having a high dielectric constant is preferably at least 10% by volume, more preferably at least 20% by volume.

Specific examples of the ester having a high dielectric constant include ethylene carbonate (EC), propylene carbonate (PC), butylene carbonate (BC), y-butyrolactone, (y-BL), ethylenesulfite (ES), etc. Among them, those having a cyclic structure such as ethylene carbonate, propylene carbonate, etc. are preferable, and cyclic carbonates are more preferable. Ethylene carbonate (EC) is most preferable.

In addition to the ester having a high dielectric constant, other solvents such as 1,2-dimethoxyethane (1,2-DME), 1,3-dioxolane (1,3-DO), tetrahydrofuran (THF), 2-methyltetrahydrofuran (2-Me-THF), diethyl ether (DEE), etc. may be used. In addition, amine or imide type organic solvents or sulfur- or fluorine-containing organic solvents may be used.

Examples of the electrolytic solute in the electrolytic solution include LiClO₄, LiPF₆, LiBF₄, LiAsF₆, LiSbF₆, LiCₙF₂ₙ₊₁SO₃ (n≧1, for example, n=3 or 4), LiCF₃CO₂, Li₂C₂F₄(SO₃)₂, LiN(CF₃SO₂)₂, LiC(CF₃SO₂)₃, etc. They may be used singly or as a mixture of two or more of them. In particular, LiPF₆ and LiC₄F₉SO₃ are preferable since they have excellent charge-discharge characteristics.

The concentration of the electrolytic solute in the electrolytic solution is not limited, and is usually from 0.3 to 1.7 mole/dm³, preferably from 0.4 to 1.5 mole/dm³.

Apart from the electrolytic solution, a solid or gel-form electrolyte may be used in the battery of the present invention. Examples of such a solid or gel-form electrolyte include inorganic solid electrolytes, organic solid electrolytes comprising polyethylene oxide, polypropylene oxide or their derivatives.

In the secondary battery of the present invention, a cross section of the lead member of the negative electrode is preferably from 0.1 to 1.0 mm², more preferably from 0.3 to 0.7 mm² to decrease the resistance and in turn the amount of heat generated in the case of a large current passing. A material of the lead member of the negative electrode is usually nickel, although copper, titanium, stainless steel, etc. maybe used. Preferably, the lead member of the negative electrode is made of a metallic material comprising copper or a copper alloy to increase the weld strength of the leadmember to the negative electrode collector which usually consists of a copper foil. Specific examples of the lead member of the negative electrode include copper, copper alloys such as copper-nickel alloys, complex materials comprising copper or a copper alloy with other metal such as nickel or titanium. Among them, a two-layered clad material of copper and nickel is preferably used.

As a lead member of the positive electrode, a lead member comprising a metal which has a low electrical resistance and withstands a high potential, for example, aluminum.

The lead member of the negative electrode or the positive electrode is preferably welded to an exposed area of the collector of the respective electrode by resistance welding, spot welding, ultrasonic welding, etc. In particular, the lead member of the negative electrode is welded by ultrasonic welding, since the spot welding may perforate the copper foil when the amount of the electric current is increased to improve the weld strength, or the weld strength tends to decrease or the welded part tends to be oxidized so that an impedance may increase.

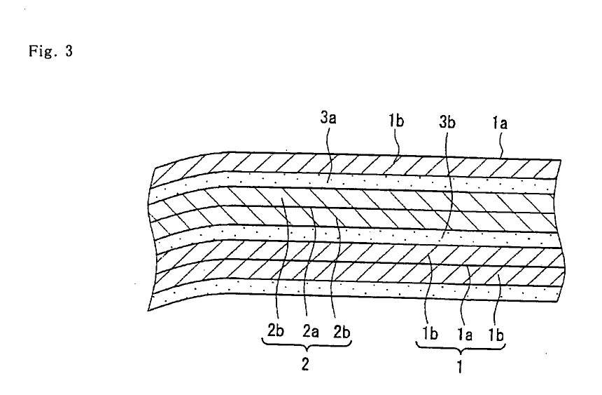

Now, a preferred embodiment of the prismatic battery according to the present invention is explained by making reference to the drawings, in which FIG. 2 schematically shows the cross section of one example of the non-aqueous electrolyte secondary battery according to the present invention, and FIG. 3 shows the enlarged view of Part A in FIG. 2. FIG. 2 is intended to illustrate the layouts of the lead member 1c of the positive electrode and the lead member 2c of the negative electrode. In the actual wound electrode body 4, the first separator 3a and the second separator 3b are present between the positive electrode 1 and the negative electrode 2 as shown in FIG. 3. However, in FIG. 2, the separators are omitted to simplify the drawing.

In FIGS. 2 and 3, the non-aqueous electrolyte secondary battery of the present invention comprises the positive electrode 1, the negative electrode 2, the first separator 3a and the second separator 3b, and the first separator 3a and the second separator 3b are impregnated with an electrolytic solution (not shown). The positive electrode 1, the first separator 3a, the negative electrode 2 and the second separator 3b are laminated in this order and wound to form the wound electrode body 4.

The positive electrode 1 comprises the positive electrode collector 1a having the layers 1b of the positive electrode mixture on the both surfaces. However, the part of the positive electrode 1, which is present in the outermost turn of the wound electrode body 4, has the layer 1b of the positive electrode mixture only on the inner surface of the positive electrode collector 1a. Thus, the outer surface of the positive electrode collector 1a is exposed in the outermost turn, and the exposed surface of the positive electrode 1a is electrically in contact with the inner surface of the exterior body 5 of the battery. In addition, the terminal part of the positive electrode 1, which is positioned in the outermost turn of the wound electrode body 4, has no layer of the positive electrode mixture on either surface of the collector 1a, and the lead member 1c of the positive electrode is attached to the terminal part of the positive electrode 1, that is, the collector 1a.

The negative electrode 2 comprises the negative electrode collector 2a having the layers 2b of the negative electrode mixture on the both surfaces. However, the part of the negative electrode 2, which is present in the innermost turn of the wound electrode body 4, has the layer 2b of the negative electrode mixture only on the inner surface of the negative electrode collector 2a. Thus the outer surface of the negative electrode collector 2a is exposed. In addition, the terminal part of the negative electrode 2, which is positioned in the innermost turn of the wound electrode body 4, has no layer of the negative electrode mixture on either surface of the collector 2a, and the leadmember 2c of the negative electrode is attached to the terminal part of the negative electrode 2, that is, the collector 2a.

### EXAMPLES

Hereinafter, the present invention will be illustrated by the following Examples, which do not limit the scope of the present invention in anyway. In the Examples, “parts” are by weight unless otherwise indicated.

### Example 1

A non-aqueous electrolyte secondary battery having the structure shown in FIGS. 2 and 3 was produced as follows:

Lithium cobalt oxide (92 parts), acetylene black (3 parts) and polyvinylidene fluoride (5 parts) were mixed in N-methyl-2-pyrrolidone as a solvent using a planetary mixer to obtain a coating composition of a positive electrode mixture. Then, the coating composition was intermittently coated on a collector consisting of an aluminum foil having a thickness of 20 μm with a blade coater, dried and pressed. The collector carrying the layer of the dried positive electrode mixture was cut to a prescribed size to obtain a sheet-form positive electrode. To the positive electrode, a lead member made of aluminum was attached by ultrasonic welding.

High density artificial graphite (d₀₀₂:0.336 nm, Lc: 100 nm) (97.5 parts), an aqueous solution of carboxymethylcellulose (concentration: 1% by weight, viscosity: 1,500 mPa.s to 5,000 mPa.s) (1.5 parts) and styrene-butadiene rubber (1 part) were mixed in an ion-exchanged water having a specific electric conductivity of at least 2.0×10⁵ Ω/cm as a solvent using a planetary mixer to obtain an aqueous coating composition of a negative electrode mixture. Then, the coating composition was intermittently coated on a copper foil having a thickness of 15 μm with a blade coater, dried and pressed. The collector carrying the layer of the dried negative electrode mixture was cut to a prescribed size to obtain a sheet-form negative electrode. To the negative electrode, a lead member made of a clad material of copper and nickel was attached by ultrasonic welding.

Separately, as the first separator, a microporous polyethylene film having a thickness of 20 μm, a gas permeability of 180 sec/100 cm³, a coefficient of thermal shrinkage in TD of 35% measured after being kept at 150° C. for 3 hours, and a porosity of 40% was provided, and as the second separator, a microporous polyethylene film having a thickness of 22 μm, a gas permeability of 80 sec/100 cm³, a coefficient of thermal shrinkage in TD of 20% measured after being kept at 150° C. for 3 hours, and a porosity of 50% was provided.

Then, the positive electrode, the first separator, the negative electrode and the second separator were laminated in this order and wound so that the first separator was present on the outer surface of the negative electrode, and the second separator was present on the inner surface of the negative electrode, to obtain a wound electrode body.

A non-aqueous electrolytic solution was prepared by dissolving LiPF₆in a mixed solvent of ethylene carbonate and diethyl carbonate in a volume ratio of 1:2 at a concentration of 1 mole/dm³.

The wound electrode body was inserted in a prismatic aluminum can. The terminal part of the lead member of the positive electrode was welded to a lid of the can, while the lead member of the negative electrode was welded to an output terminal. Then, the electrolytic solution was poured in the can, and then the lid was sealed to the main body of the can to assemble a non-aqueous electrolyte secondary battery with 800 mAh. With this secondary battery, the inner surface of the aluminum can and the exposed outer surface of the collector of the positive electrode made of the aluminum foil were directly in contact with each other to establish conduction.

### Example 2

A non-aqueous electrolyte secondary battery was produced in the same manner as in Example 1 except that as the first separator, a microporous polyethylene film having a thickness of 20 μm, a gas permeability of 180 sec/100 cm³, a coefficient of thermal shrinkage in TD of 35% measured after being kept at 150° C. for 3 hours, and a porosity of 40% was used, and as the second separator, a microporous polyethylene film having a thickness of 20 μm, a gas permeability of 120 sec/100 cm³, a coefficient of thermal shrinkage in TD of 30% measured after being kept at 150° C. for 3 hours, and a porosity of 50% was used.

### Example 3

A non-aqueous electrolyte secondary battery was produced in the same manner as in Example 1 except that as the first separator, a microporous polyethylene film having a thickness of 22 μm, a gas permeability of 300 sec/100 cm³, a coefficient of thermal shrinkage in TD of 40% measured after being kept at 150° C. for 3 hours, and a porosity of 40% was used, and as the second separator, a microporous polyethylene film having a thickness of 20 μm, a gas permeability of 100 sec/100 cm³, a coefficient of thermal shrinkage in TD of 25% measured after being kept at 150° C. for 3 hours, and a porosity of 40% was used.

### Example 4

A non-aqueous electrolyte secondary battery was produced in the same manner as in Example 1 except that as the first separator, a microporous polyethylene film having a thickness of 22 μm, a gas permeability of 400 sec/100 cm³, a coefficient of thermal shrinkage in TD of 25% measured after being kept at 150° C. for 3 hours, and a porosity of 40% was used, and as the second separator, a microporous polyethylene film having a thickness of 20 μm, a gas permeability of 120 sec/100 cm³, a coefficient of thermal shrinkage in TD of 30% measured after being kept at 150° C. for 3 hours, and a porosity of 50% was used.

### Comparative Example 1

A non-aqueous electrolyte secondary battery was produced in the same manner as in Example 1 except that as the first separator, a microporous polyethylene film having a thickness of 20 μm, a gas permeability of 180 sec/100 cm³, a coefficient of thermal shrinkage in TD of 35% measured after being kept at 150° C. for 3 hours, and a porosity of 40% was used, and as the second separator, a microporous polyethylene film having a thickness of 20 μm, a gas permeability of 150 sec/100 cm³, a coefficient of thermal shrinkage in TD of 35% measured after being kept at 150° C. for 3 hours, and a porosity of 40% was used.

### Comparative Example 2

A non-aqueous electrolyte secondary battery was produced in the same manner as in Example 1 except that as the first separator, a microporous polyethylene film having a thickness of 22 μm, a gas permeability of 400 sec/100 cm³, a coefficient of thermal shrinkage in TD of 25% measured after being kept at 150° C. for 3 hours, and a porosity of 40% was used, and as the second separator, a microporous polyethylene film having a thickness of 20 μm, a gas permeability of 150 sec/100 cm³, a coefficient of thermal shrinkage in TD of 35% measured after being kept at 150° C. for 3 hours, and a porosity of 40% was used.

### Comparative Example 3

A non-aqueous electrolyte secondary battery was produced in the same manner as in Example 1 except that as the first separator, a microporous polyethylene film having a thickness of 22 μm, a gas permeability of 500 sec/100 cm³, a coefficient of thermal shrinkage in TD of 30% measured after being kept at 150° C. for 3 hours, and a porosity of 40% was used, and as the second separator, a microporous polyethylene film having a thickness of 22 μm, a gas permeability of 80 sec/100 cm³, a coefficient of thermal shrinkage in TD of 20% measured after being kept at 150° C. for 3 hours, and a porosity of 50% was used.

Each of the secondary batteries produced in Examples 1-4 and Comparative Examples 1-3 was charged at 1 C (800 mA) up to 4.2 V and further at a constant voltage of 4.2 V for 3 hours, and then discharged at 0.2 C down to 3V. Thereby, a discharge capacity was measured.

Ten (10) secondary batteries produced in each of Examples 1-4 and Comparative Examples 1-3 were charged at 1 C up to 12 V. Then, the number of the batteries with which the battery temperature rose to 135° C. or higher due to internal short-circuiting was counted.

The results are shown in Table 1. In Table 1, the number (n) of the batteries with which the battery temperature rose to 135° C. or higher is expressed in the form of “n/10”.

Furthermore, each of the secondary batteries produced in Examples 1-4 and Comparative Examples 1-3 was charged at 1 C up to 4.2 V and further at a constant voltage of 4.2 V for 3 hours, and then discharged at 0.2 C down to 3V to measure a discharge capacity. Ten secondary batteries produced in each of Examples 1-4 and Comparative Examples 1-3 were charged at 1 C up to 4.25 V and further at a constant voltage of 4.25 V for 3 hours. All the batteries were placed in an oven and heated from room temperature to 150° C. and maintained at 150° C. for 3 hours. In this heating process, the number of the batteries with which the surface temperature rose to 200° C. or higher due to the thermal runaway was counted. The results are shown in Table 1. In Table 1, the number (N) of the batteries with which the surface temperature rose to 200° C. or higher is expressed in the form of “N/10”.

TABLE 1

| | | | Coefficient | | | | |
|---|---|---|---|---|---|---|---|
| | Gas | | of thermal | | | | |
| | permeability | | shrinkage in | | | | |
| | of separator | | TD of separator | | Discharge | | |
| | (sec/100 cm³) | | (%) | | capacity | n/ | N/ |
| | First | Second | First | Second | (mAh) | 10⁺¹⁾ | 10⁺²⁾ |
| Ex. 1 | 180 | 80 | 35 | 20 | 800 | 0/10 | 0/10 |
| Ex. 2 | 180 | 120 | 35 | 30 | 800 | 0/10 | 0/10 |
| Ex. 3 | 300 | 100 | 40 | 25 | 800 | 0/10 | 0/10 |
| Ex. 4 | 400 | 120 | 25 | 30 | 780 | 0/10 | 0/10 |
| C. E. 1 | 180 | 150 | 35 | 35 | 800 | 0/10 | 6/10 |
| C. E. 2 | 400 | 150 | 25 | 35 | 780 | 0/10 | 7/10 |
| C. E. 3 | 500 | 80 | 30 | 20 | 760 | 6/10 | 0/10 |

Notes:
¹⁾The number of the batteries with which the battery temperature rose to 130° C. or higher among ten batteries.
²⁾The number of the batteries with which the surface temperature rose to 200° C. or higher among ten batteries.

As can bee seen from the results in Table 1, no thermal runaway was observed with the batteries of Examples 1-4 in the charging step at 1 C up to 12 V or the heating in the oven at 150° C. In contrast, with the batteries of Comparative Examples 1 and 2, no thermal runaway was observed in the charging step at 1 C up to 12 V, but several batteries were heated to 200° C. or higher due to thermal runaway when they were stored in the oven at 150° C. With the batteries of Comparative Example 3, no thermal runaway was observed when they were heated in the oven at 150° C., but several batteries were heated to 135° C. or higher due to thermal runaway when they were charged at 1 C up to 12 V.

1. A non-aqueous electrolyte secondary battery comprising a positive electrode, a negative electrode and two kinds of separators which are laminated and wound to form a wound electrode body, and a non-aqueous electrolytic solution, wherein the first separator having a gas permeability of 400 sec/100 cm³ or less is provided on the outer surface of the negative electrode, and the second separator having a coefficient of thermal shrinkage of 30% or less in a widthwise direction after being kept at 150° C. for 3 hours is provided on the inner surface of the negative electrode.

2. The non-aqueous electrolyte secondary battery according to claim 1, wherein each of the first and second separators has a thickness of 25 μm or less.

3. The non-aqueous electrolyte secondary battery according to claim 1, wherein each of the first and second separators has a porosity of 60% or less.

4. The non-aqueous electrolyte secondary battery according to claim 1, wherein said wound electrode body is in the form of a cylinder having a circular or elliptical bottom, and inserted in an exterior body consisting of a metal can.
